(19) United States
(12) Patent Application Publication
(10) Pub. No.: US 2002/0037785 A1
(43) Pub. Date: Mar. 28, 2002

(54) Controllable planetary gear

(76) Inventors: Walter Wissmach, Munich (DE); Ferdinand Kristen, Gilching (DE); Edwin Schweizer, Balzers (LI); Michael Mergenbaum, Feldkirch (AU)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/963,074

(22) Filed: Sep. 24, 2001

(30) Foreign Application Priority Data
Sep. 25, 2000 (DE) 100 47 312.1

(51) Int. Cl. F16H 3/54

(52) U.S. Cl. 475/149

(57) ABSTRACT

A controllable planetary gear for transmitting a rotational movement between an input (2) and an output (3), including a ring gear (4) with which a speed range of the transmitted rotational movement is controlled; and a control device (6, 6¹) having an inner member (5, 5¹) in which the ring gear (4) is integrated, an outer member (7, 7¹) supportable in the tool housing (3) without a possibility of rotation relative thereto, and a sensor (8, 8¹) for measuring a force acting on the outer member (7, 7¹) and a tension developed in the outer member (7, 7¹).

### BACKGROUND OF THE INVENTION

1. Field of the Invention

The present invention relates to a controllable planetary gear, in particular, for hand-held power tools such as, e.g., drills, hammer drills, chisel hammer, etc., having a rotary drive.

2. Description of the Prior Art

Generally, a planetary gear consists of a ring gear with inner toothing, a coaxial with the ring gear, sun gear with outer toothing, and several planet gears arranged in a ring space formed between the ring and sun gears and having each an outer toothing engageable with respective inner and outer toothings of the ring and sun gears. Optionally, coaxial, circumferential points of rotation of the planet gears can be arranged in a coaxial planet carrier.

Of many fields of application of planetary gears, the present invention is limited to the transmission of rotational movement between input and output with a controllable speed range. In addition to freely selectable input and output, there is always available a further degree of freedom that can be used for controlling the transmission ratio.

With respect to the input and output, the present invention is limited to a case in which the input and output are associated, respectively, with the sun gear and the planet carrier, which leaves the ring gear for control purposes.

U.S. Pat. No. 4,828,049 discloses a hand-held power drill in which a planetary gear is used for reducing the rotational speed, with the input and output being associated, respectively, with the sun gear and the planet carrier. The ring gear is always fixed in the housing and is not used for controlling the planetary gear.

U.S. Pat. No. 4,231,270 discloses a planetary gear for a hand-held power screw-driving tool and in which the sun gear and the planet carrier are associated, respectively, with input and output. Additionally, a manually actuated, by applying pressure acting in axial direction, clutch, which separates power flow from the motor to the operating spindle, is used. In the engagement condition of the clutch, the controllable, axially displaceable, outer ring gear is formlockingly connected with the tool housing without a possibility of rotation relative thereto. Optionally, a microswitch, which is axially connected with both the ring gear and the housing, interrupts, in the engagement condition of the clutch, power supply to the electric motor of the tool.

European Publication EP0212381 discloses a planetary gear for a hand-held power drill in which the sun gear and the planet carrier are associated, respectively, with the input and output and which is used with a friction clutch that is arranged between the controllable ring gear of the planetary gear and a non-rotatable support in the housing. The clutch is spring preloaded.

U.S. Pat. No. 5,076,120 discloses a planetary gear for a hand-held power drilling screw and having the sun gear and the planet carrier associated, respectively, with the input and the output, and the ring gear of which is fixedly connected with the tool housing, and which included an axially displaceable electromagnetic clutch.

German Publication DE4344817 discloses a hammer drill with a safety circuit for preventing injury of the user in case of a sudden jamming of the working tool. Upon a sudden dangerous jamming of the working tool, the safety circuit actuates an electromagnetic safety clutch that immediately separates the electromotor from the drive gear before the electromotor, which continues to rotate as a result of its rotational energy, runs out after the power supply to the electromotor has been interrupted. The safety circuit includes torque sensor means that generates an actuation signal when the torque transmitted to the working tool exceeds a predetermined value. The safety clutch, which represents an additional component, requires an additional space in the housing interior, which increases dimensions of the housing, the weight of the entire tool, and manufacturing costs.

Japanese Publication JP 58127137 discloses a planetary gear in which for measuring the torque, the support reaction force, necessary for securing the ring gear in the housing, is measured.

One object of the present invention is to provide means with minimal number of components for controlling a planetary gear for transmitting a rotational movement between input and output, with a speed range being controlled as a torque function.

Another object of the present invention is to shorten an axial shaft region necessary for control purposes, in particular when a power tool, which has a safety circuit for preventing an adverse affect of a working tool jamming, is used.

### SUMMARY OF THE INVENTION

These and other objects of the present invention, which will become apparent hereinafter are achieved by providing a controllable planetary gear for transmitting a rotational movement between input and output with a controllable speed range, which is controlled with a ring gear of the planetary gear, with the planetary gear including control means having an inner member, into which the ring gear is integrated, and an outer member which is supported in the housing without a possibility of rotation relative thereto and which has a sensor for measuring the force acting thereon or the tension therein.

According to the present invention, the torque at the input or output of the controlled by the control means, planetary gear is directly proportional to the support reaction force of the outer member of the control means which is arranged in the housing. The control means controls the functioning of the planetary gear in accordance with the measured support reaction force acting on its outer member.

Thus, both the measurement of the torque and control of the torque over the speed range of the planetary gear is effected with the outer member of the control means.

Advantageously, the control means is formed as a continuously operating frictional brake with controllable movable friction elements, e.g., a brake disc with an active sector section or a circumferentially acting brake band.

The control means can also be formed as a discrete statically frictional clutch with spring-biased engagement means, or as a rotationally formlocking safety clutch with a displaceable release mechanism, e.g., with a pawl.

Advantageously, the control means is so formed that it can be mechanically adjusted, e.g., with a control member or a biasing spring accessible from outside.

The control means can also be so formed that it can be advantageously electrically adjusted, e.g., as actuation means that can be actuated or preloaded with electromagnetic means, with the winding being connected with the outer member without a possibility of rotation relative thereto, and with the inner member being formed of a ferromagnetic material.

Advantageously, the electrical actuation means is controlled electronically, from inside of the tool housing, by a microcontroller arranged in the housing. Advantageously, the microcontroller controls the actuation means in accordance with signals generated by the arranged in or on the outer member, sensor for determining the torque.

Advantageously, the control means is formed as combination means including an inner member that forms the ring gear with the inner toothing, and an intermediate member that circumferentially surrounds the inner member and forms an outer component of a friction clutch and an inner component of another control means having an outer member, e.g., of a safety clutch.

Advantageously, the outer member of another control means has its end surface engaging the intermediate member, which advantageously provides for the axial displacement of the intermediate member.

Advantageously, the inner member, the intermediate member, and/or the outer member of the control means are arranged in a common axial region, nesting radially in each other.

There is further advantageously provided, according to the present invention, safety means that prevents excessive rotation of the tool housing. The microcontroller, which is located in the tool housing, is connected with the sensor, which is mounted on or in the outer member of the control means, and with the safety means. The safety means is advantageously formed as an electrically actuatable safety clutch that upon jamming of the working tool, interrupts transmission of the rotational movement from the input of the planetary gear, which is connected with the drive motor, to the planetary gear output which is connected with the working tool spindle. The safety clutch provides for disconnection of the inner member of the control means and in which the ring gear of the planetary gear is integrated, from the outer member of the control means and which is connected with the tool housing without a possibility of rotation relative to the housing. As a result of the disconnection the ring gear can rotate freely.

As discussed above, the combination friction-safety clutch, with the inner and intermediate member forming the friction clutch and the intermediate and outer member forming the safety clutch, has the inner, intermediate, and outer members located in a common axial region and nested in each other. This permits to reduce the number of components of the control means, the space occupied by the control means, the weight of the control means and, thus, the weight of the tool itself, and last but not the least, manufacturing costs associated with manufacturing and assembly of the control means and of the tool itself.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal cross-sectional view of a planetary gear according to the present invention;

FIG. 2 an end side cross-sectional view of the planetary gear shown in FIG. 1; and

FIG. 3 a side, partially cross-sectional view of a hand-held power tool with a planetary gear according to the present invention

### DETAILED DESCRIPTION OF THE PREFERRED EMBODIMENT

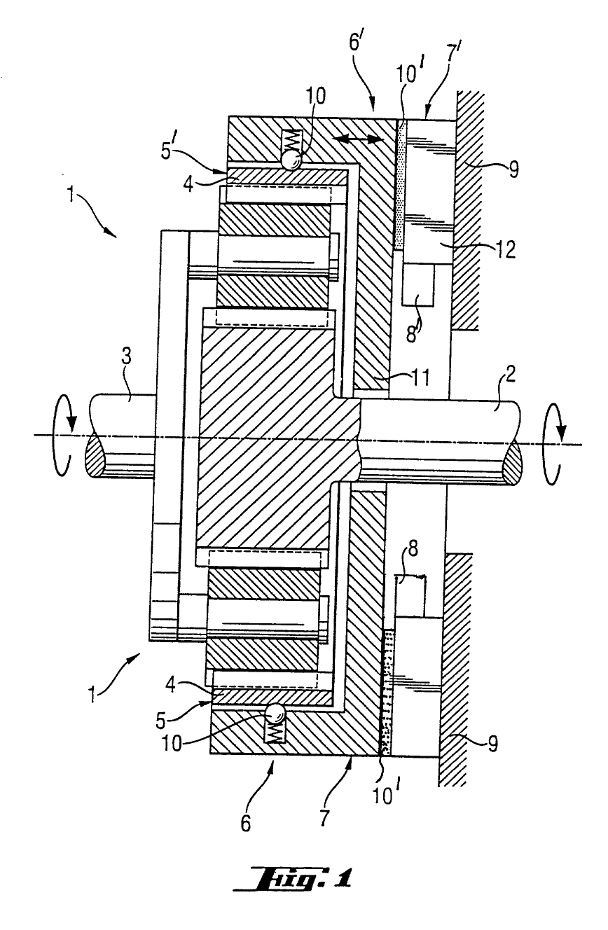

A planetary gear 1 according to the present invention, which is shown in the drawings, is used for transmission of a rotational movement between an input 2 connected with sun gear and an output 3 connected with planet carrier. The planetary gear 1 includes a ring gear 4 with inner toothing and which is integrated in a rotatable inner member 5 of control means 6, as shown in the lower half of FIG. 1. The control means 6 further includes an outer member 7 secured against rotation relative to a housing 9. The outer member 7 includes a sensor 8 for measuring a force acting on the outer member 7, in which case the sensor 8 is formed as a piezosensor, or for measuring tension in the outer member 7, in which case the sensor 8 is formed as a strain gauge. The control means 6 further includes a contact element 10, which is provided between the inner and outer members 5 and 7 and controls the rotational movement of the ring gear 4. The contact element 10 is formed as a friction clutch having spring-biased balls which frictionally engage the inner member 5 of the control means 6. The planetary gear 1 and the control means 6 are at least partially radially nested in each other within a common axial region.

The outer member 7 of the control means 6 forms an intermediate member 11 that is formed of metal. The intermediate member 11 has its housing-side end side connected with actuation means 12 that is formed as a conductive winding and provides for an axial displacement of the intermediate member 11. The actuation means 12 is arranged within the outer member 7 of the control means 6.

According to the present invention, there is further provided another control means 6¹, shown in the upper half of FIG. 1, formed as an electromagnetic safety clutch and including a contact element 10¹ formed as a frictionally sliding, double sided, brake lining that is provided at an end side of the planetary gear 1, an inner member 5¹ in which the ring gear 4 is integrated, an outer member 7¹ secured to the housing 9 without a possibility of rotation relative thereto, and a sensor 8¹ provided on or in the outer member 7¹.

According to the invention, both control means 6 and 6¹ are integrated in each other, with the inner members 5 and 5¹, the outer members 7, 7¹, and the sensors 8, 8¹ of the control means 6 and 6¹ forming respective integrated elements with the located radially outwardly contact element 10 and located axially, at the end side, contact element 10¹, there is provided to integrated into each other, control means 6 and 6¹, which occupy very little space and includes clutch elements 10 and 10¹, respectively, which can be easily separated from each other.

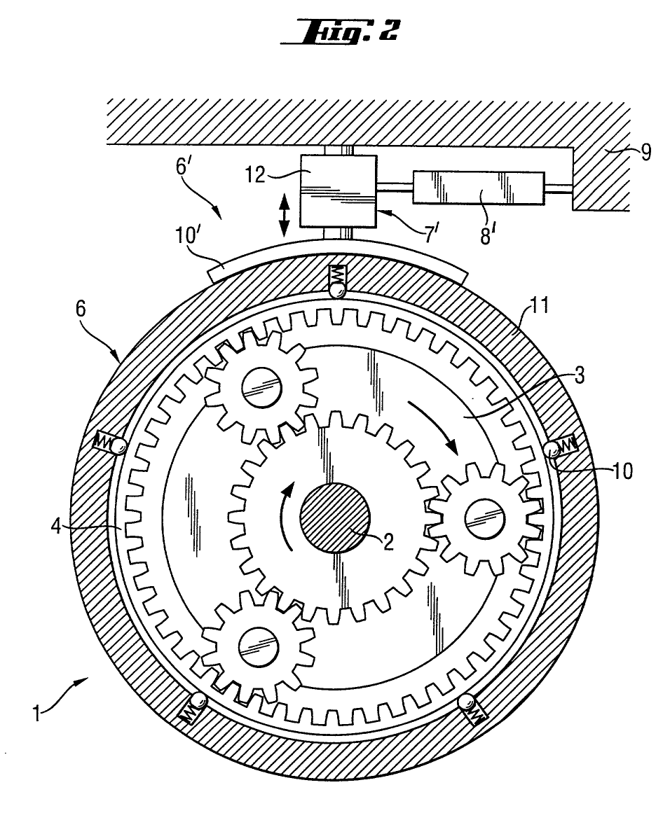

FIG. 2 shows, in somewhat more detailed manner, the another control means 6¹ for changing, in a controlled manner, the speed of the ring gear 4. The control means 6¹ is formed as a brake that continuously changes the torque which is transmitted by the planetary gear 1. The actuation means 12, which is located in the outer member 7¹ of the control means 6¹, connects the contact element 10¹, which is formed as a sector-shaped, braking, arcuate plate, with the housing 9. The another control means 6¹ is separated from the control means 6, which includes the contact elements 10 forming a friction clutch and formed of spring-biased balls.

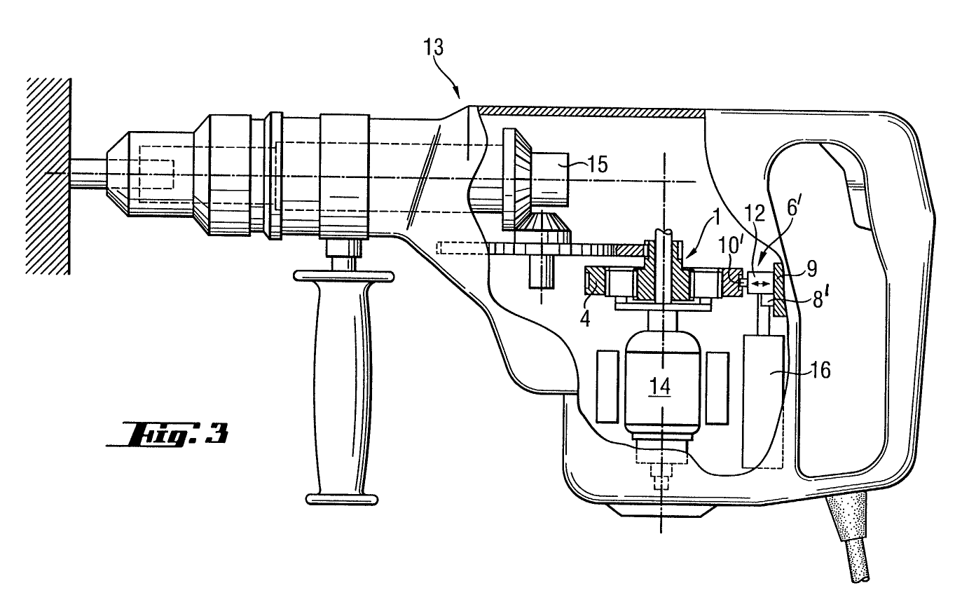

FIG. 3 shows a hand-held power tool 13 including the planetary gear 1 which is arrange between the drive motor 14 and the working tool spindle 15. As shown, the ring gear 4 and the another control means 6¹, which is formed as a safety clutch, are located in the same axial region and are nested in each other, with the contact element 10¹ forming radially displaceable stop element connected by the actuation means 12, which is formed as a solenoid-operated switch, with the housing 9. The sensor 8¹, which measures the support reaction force of the ring gear 4 of the planetary gear 1, is arranged on the actuation means 12, without a possibility of rotation relative to the housing 9. The sensor 8¹ is connected with a microcontroller 16. The microcontroller calculates, in accordance with a signal generated by the sensor 8, an angular acceleration. When the angular acceleration exceeds a predetermined threshold, the microcontroller sends a signal to the actuation means 12 to withdraw the stop element 10¹, so that the ring gear 4 can freely rotate. Thereby, no transmission of the rotational movement takes place between the motor 14 and the spindle 15.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A controllable planetary gear for a hand-held power tool having a housing (9) for transmitting a rotational movement between an input (2) and an output (3), comprising a ring gear (4) with which a speed range of the transmitted rotational movement is controlled; and control means (6, 6¹) having an inner member (5, 5¹) in which the ring gear (4) is integrated, an outer member (7, 7¹) supportable in the tool housing (3) without a possibility of rotation relative thereto, and a sensor (8, 8¹) for measuring one of a force acting on the outer member (7, 7¹) and a tension developed in the outer member (7, 7¹).

2. A controllable planetary gear according to claim 1, wherein the control means is formed as one of a continuously frictionally engaging brake with controllable movable friction members, a discrete statically frictionally engaging friction clutch with spring-biased engaging elements, and a rotationally engaging safety clutch with movable release means.

3. A controllable planetary gear according to claim 1, further comprising actuation means (12) for one of mechanically and electrically controlling the control means.

4. A controllable planetary gear according to claim 3, wherein the actuation means is formed as electromagnetic means.

5. A controllable planetary gear according to claim 3, wherein the actuation means is electronically controlled by a microprocessor of the power tool.

6. A controllable planetary gear according to claim 5, wherein the microcontroller is connected with the sensor (8).

7. A controllable planetary gear according to claim 1, comprising further control means (6, 6¹) having inner (5, 5¹) and outer members (7, 7¹); and an intermediate member (11) arranged between the inner member (5) of the control means (6¹) and the outer member (7¹) of further control means (6¹) integrating same.

8. A controllable planetary gear according to claim 7, wherein the outer member (7¹) of the further control means (6^{1v}) is arranged at an end side of the intermediate member (5) for axially displacing same.

9. A controllable planetary gear according to claim 7, wherein the inner member (5) of the control means (6) and at least one of the intermediate member and the outer member (7¹) of the further control means (6¹) are located in a common axial region and are radially nested in each other.

10. A controllable planetary gear according to claim 1, wherein the planetary gear (1) is located between a drive motor (14) and the working tool spindle (15) of the power tool.
